(19) United States
(12) Patent Application Publication
(10) Pub. No.: US 2019/0113720 A1
(43) Pub. Date: Apr. 18, 2019

(54) PHOTOGRAPHING DEVICE AND METHOD FOR SWITCHING PHOTOGRAPHING FUNCTION

(71) Applicant: Wistron Corp., New Taipei City (TW)

(72) Inventors: Kun-Da Lee, New Taipei City (TW); Cong-Wei Cai, New Taipei City (TW)

(21) Appl. No.: 15/869,695

(22) Filed: Jan. 12, 2018

(30) Foreign Application Priority Data
Oct. 18, 2017 (TW) 106135679

(51) Int. Cl. G02B 13/06; H04N 5/232; G02B 9/06; H04N 5/225

(52) U.S. Cl. CPC G02B 13/06; H04N 5/23245; H04N 5/23238; H04N 5/2254; G02B 9/06

(57) ABSTRACT

A photographing device is provided. The photographing device includes a first casing, a second casing, a first wide-angle lens, a second wide-angle lens, an axle and a controlling device. The first wide-angle lens is assembled on the first casing and the second wide-angle lens is assembled on the second casing. The axle is coupled to the first casing and the second casing to open or close the first casing and the second casing. The controlling device detects whether the first casing and the second casing are completely opened or closed to determine whether to enable a virtual reality (VR) function or a 360-degree panoramic function.

### CROSS REFERENCE TO RELATED APPLICATIONS

This Application claims priority of TW Patent Application No. 106135679 filed on Oct. 18, 2017, the entirety of which is incorporated by reference herein.

### BACKGROUND OF THE INVENTION

### Field of the Invention

The invention generally relates to photographing device technology, and more particularly, to a photographing device technology for combining a virtual reality (VR) function and a 360-degree (360°) panoramic function.

### Description of the Related Art

As image-processing technology progresses, photographing devices with different functions are being developed.

Virtual reality (VR) and 360-degree (360°) panoramic photographing technologies are popular image-processing technologies that are currently being applied in photographing devices. If VR photographing technology and 360-degree panoramic photographing technology can be combined in a photographing device, the functionality and the practicality of the photographing device will be increased.

BRIEF SUMMARY OF THE INVENTION

A photographing device, which has a virtual reality (VR) function and a 360-degree (360°) panoramic function, and a method for switching photographing functions are provided to overcome the problems mentioned above.

An embodiment of the invention provides a photographing device. The photographing device comprises a first casing, a second casing, a first wide-angle lens, a second wide-angle lens, an axle, and a controlling device. The first wide-angle lens is assembled on the first casing. The second wide-angle lens is assembled on the second casing. The axle is coupled to the first casing and the second casing to open or close the first casing and the second casing. The controlling device detects whether the first casing and the second casing are opened or closed completely to determine whether to enable a virtual reality (VR) function or a 360-degree panoramic function.

In some embodiments, the first casing has a first boundary and a second boundary and the second casing has a third boundary and a fourth boundary, wherein the second boundary and the fourth boundary are connected to the axle. When the first casing and the second casing are opened completely, the second boundary and the fourth boundary are close-fitting, and when the first casing and the second casing are closed completely, the first boundary and the third boundary are close-fitting.

In some embodiments, the photographing device further comprises a first sensor and a second sensor. The first sensor is configured in the first boundary or the third boundary. The second sensor is configured in the second boundary or the fourth boundary. The controlling device detects a first sensing value generated by the first sensor and detects a second sensing value generated by the second sensor to determine whether to enable a virtual reality (VR) function or a 360-degree panoramic function.

In some embodiments, the photographing device further comprises a first mechanism and a second mechanism. The first mechanism is configured in the first boundary or the third boundary, and the second mechanism is configured in the second boundary or the fourth boundary. The controlling device detects a first sensing value triggered by the first sensor and detects a second sensing value triggered by the second sensor to determine whether to enable a virtual reality (VR) function or a 360-degree panoramic function.

An embodiment of the invention provides a method for switching photographing functions. The method is applied in a photographing device which comprises a first casing and a second casing. The method comprises: detecting whether the first casing and the second casing are opened or closed completely to determine whether to enable a virtual reality (VR) function or a 360-degree panoramic function; wherein when the first casing and the second casing are opened completely, enabling the VR function, and wherein when the first casing and the second casing are closed completely, enabling the 360-degree panoramic function.

Other aspects and features of the invention will become apparent to those with ordinary skill in the art upon review of the following descriptions of specific embodiments of methods and devices.

### BRIEF DESCRIPTION OF THE DRAWINGS

The invention will become more fully understood by referring to the following detailed description with reference to the accompanying drawings, wherein:

FIG. 1 is a block diagram of a photographing device 100 according to an embodiment of the invention;

FIG. 2A-2C are schematic diagrams illustrating a photographing device 100 according to an embodiment of the invention;

FIG. 3 is a flow chart 300 illustrating a method for switching photographing functions according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

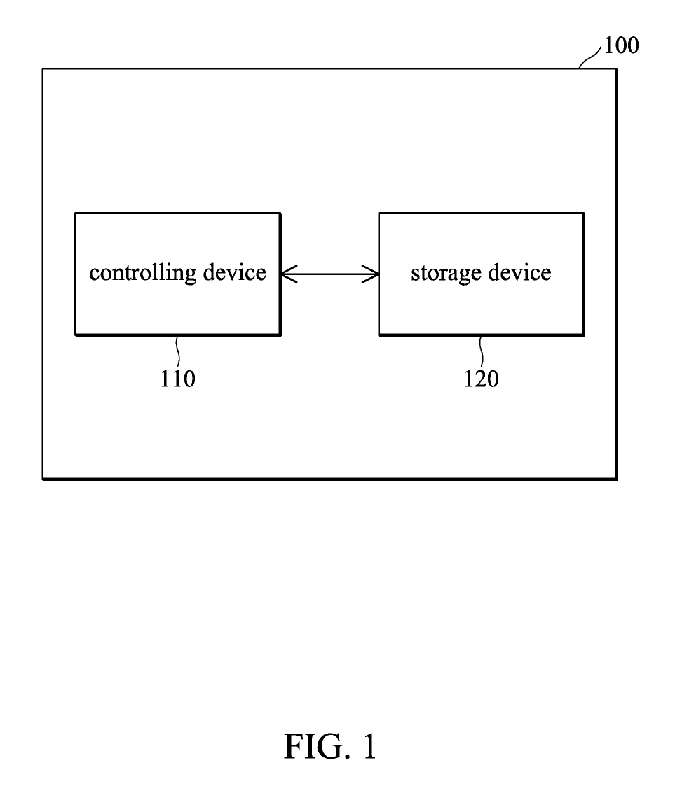

FIG. 1 is a block diagram of a photographing device 100 according to an embodiment of the invention. As shown in FIG. 1, the photographing device 100 may comprise a controlling device 110 and a storage device 120. Note that, FIG. 1 presents a simplified block diagram in which only the elements relevant to the invention are shown. However, the invention should not be limited to what is shown in FIG. 1. The photographing device 100 also can comprise other elements.

In an embodiment of the invention, the photographing device 100 may be a processor or a controlling circuit.

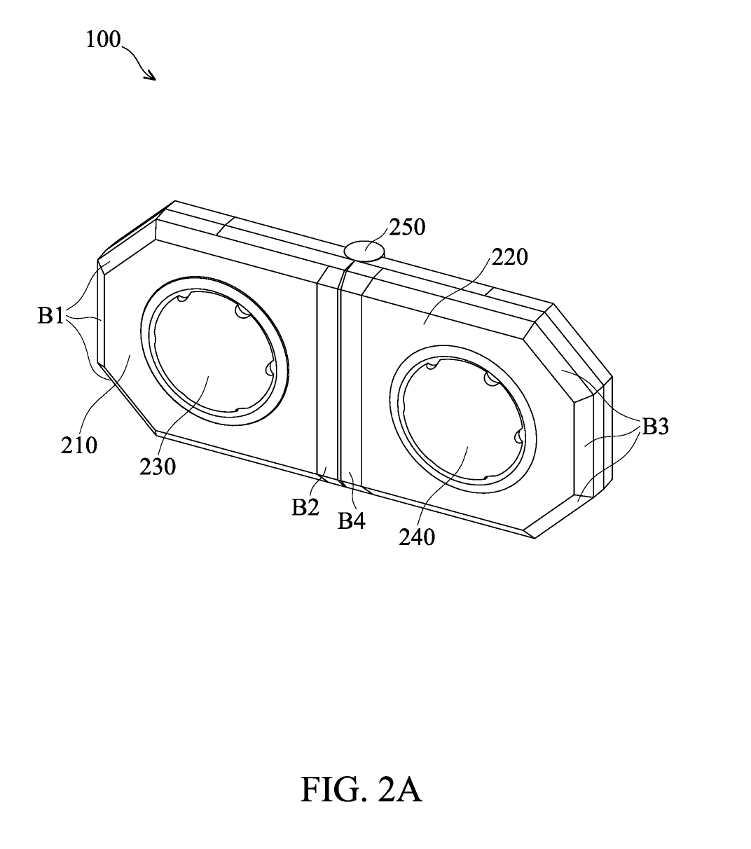

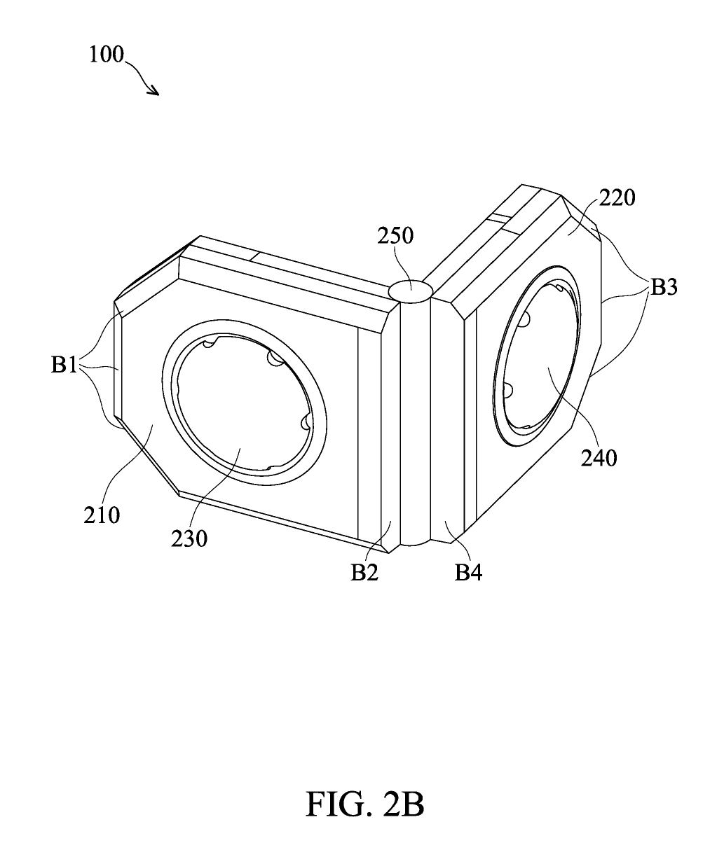

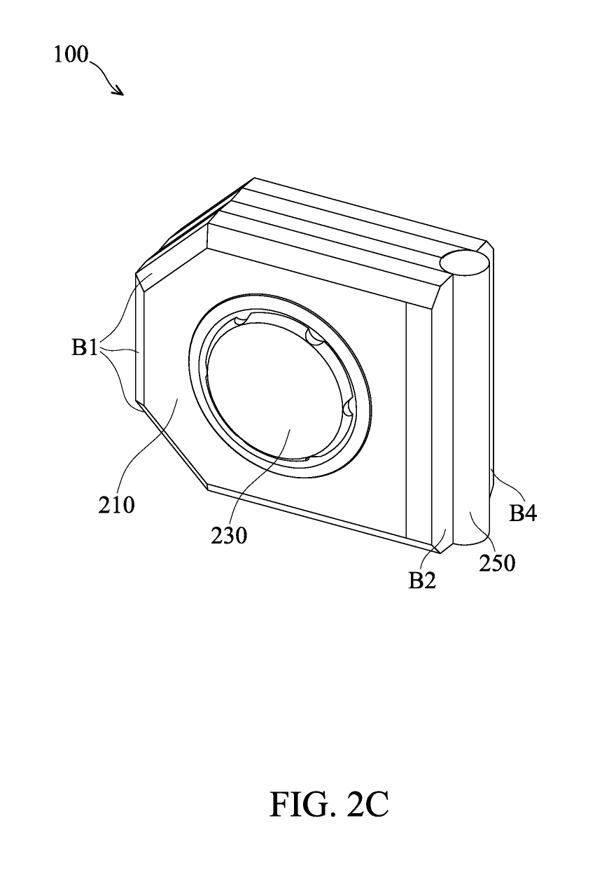

FIGS. 2A-2C are schematic diagrams illustrating a photographing device 100 according to an embodiment of the invention. As shown in FIGS. 2A-2C, the photographing device 100 may comprise a first casing 210, a second casing 220, a first wide-angle lens 230, a second wide-angle lens 240 and an axle 250. It should be noted that the schematic diagrams shown in FIGS. 2A-2C are only utilized to illustrate the embodiments of the invention, but the invention should not be limited thereto. In the embodiment of the invention, the first wide-angle lens 230 and the second wide-angle lens 240 may be the lenses whose field of view (FOV) is greater than 180 degrees.

In an embodiment of the invention, the first casing 210 and the second casing 220 have a symmetrical shape and size, and the first casing 210 and the second casing 220 are connected (or coupled) to each other through the axle 250. The first casing 210 and the second casing 220 may be opened or closed through the axle 250. In an embodiment of the invention, as shown in FIGS. 2A-2C, the first casing 210 has a first boundary B1 and a second boundary B2 and the second casing 220 has a third boundary B3 and a fourth boundary B4. The second boundary B2 is connected to the fourth boundary B4 through the axle 250. When the first casing 210 and the second casing 220 are opened completely (as shown in FIG. 2A), the second boundary B2 and the fourth boundary B4 will be close-fitting. When the first casing 210 and the second casing 220 are closed completely (as shown in FIG. 2C), the first boundary B1 and the third boundary B3 will be close-fitting.

In an embodiment of the invention, the first wide-angle lens 230 is assembled on the first casing 210 and the second wide-angle lens 240 is assembled on the second casing 220. The assembled positions of the first wide-angle lens 230 and the second wide-angle lens 240 are symmetrical. When the first casing 210 and the second casing 220 are opened completely (as shown in FIG. 2A), the first wide-angle lens 230 and the second wide-angle lens 240 can be utilized to realize a virtual reality (VR) function. When the first casing 210 and the second casing 220 are closed completely (as shown in FIG. 2C), the first wide-angle lens 230 and the second wide-angle lens 240 can be utilized to realize a 360-degree (360°) panoramic function. That is to say, when the first casing 210 and the second casing 220 are opened completely, the first wide-angle lens 230 and the second wide-angle lens 240 can be utilized to simulate the left eye and right eye to perform the photography to generate the VR image. When the first casing 210 and the second casing 220 are closed completely, the photographing device 100 can be regarded as a 360-degree panoramic camera. The first wide-angle lens 230 and the second wide-angle lens 240 may be respectively utilized to perform the front 180-degree photography and the back 180-degree photography to realize the 360-degree panoramic function.

In an embodiment of the invention, the photographing device 100 further comprises a first sensor (not shown in figures) and a second sensor (not shown in figures). The first sensor and the second sensor may be Hall sensors or photo sensors, but the invention should not be limited thereto. The controlling device 110 may detect the sensing values generated by the first sensor and the second sensor. In an embodiment of the invention, the first sensor is configured in the first boundary B1 or the third boundary B3. When the first casing 210 and the second casing 220 are closed completely (as shown in FIG. 2C) (i.e. the first boundary B1 and the third boundary B3 are close-fitting), the first sensor may generate a sensing signal S1. When the controlling device 110 receives the sensing signal S1, the controlling device 110 may enable the 360-degree panoramic function. In an embodiment of the invention, the second sensor is configured in the second boundary B2 or the fourth boundary B4. When the first casing 210 and the second casing 220 are opened completely (as shown in FIG. 2A) (i.e. the second boundary B2 and the fourth boundary B4 are close-fitting), the second sensor may generate a sensing signal S2. When the controlling device 110 receives the sensing signal S2, the controlling device 110 may enable a VR function.

In another embodiment of the invention, the photographing device 100 further comprises a first mechanism (not shown in figures) and a second mechanism (not shown in figures). The first mechanism and the second mechanism may be thimble mechanisms or shrapnel mechanisms, but the invention should not be limited thereto. The controlling device 110 may detect the sensing values triggered by the first mechanism and the second mechanism. In an embodiment of the invention, the first mechanism is configured in the first boundary B1 or the third boundary B3. When the first casing 210 and the second casing 220 are closed completely (as shown in FIG. 2C) (i.e. the first boundary B1 and the third boundary B3 are close-fitting), the first mechanism may trigger a sensing signal S3. When the controlling device 110 receives the sensing signal S3, the controlling device 110 may enable the 360-degree panoramic function. In an embodiment of the invention, the second mechanism is configured in the second boundary B2 or the fourth boundary B4. When the first casing 210 and the second casing 220 are opened completely (as shown in FIG. 2A) (i.e. the second boundary B2 and the fourth boundary B4 are close-fitting), the second mechanism may trigger a sensing signal S4. When the controlling device 110 receives the sensing signal S4, the controlling device 110 may enable a VR function.

In an embodiment of the invention, when the first casing 210 and the second casing 220 are in a rotatable state (as shown in FIG. 2B) (i.e. the first casing 210 and the second casing 220 are not opened or closed completely), the controlling device 110 may terminate the VR function or a 360-degree panoramic function which is being performed. When the first casing 210 and the second casing 220 are switched from a fully open state (as shown in FIG. 2A) to the rotatable state, the controlling device 110 may terminate the VR function and store the data generated by performing the VR function to the storage device 120. When the first casing 210 and the second casing 220 are switched from a fully closed state (as shown in FIG. 2C) to the rotatable state, the controlling device 110 may terminate the 360-degree panoramic function and store the data generated by performing the 360-degree panoramic function to the storage device 120.

In an embodiment of the invention, the photographing device 100 further comprises a display panel (not shown in figure). The display panel may display information indicating whether the first casing 210 and the second casing 220 are currently in a fully open state (as shown in FIG. 2A), a fully closed state (as shown in FIG. 2C), or a rotatable state (as shown in FIG. 2B). In an embodiment of the invention, the display panel may display information indicating whether the first casing 210 and the second casing 220 are currently in a fully open state (as shown in FIG. 2A), a fully closed state (as shown in FIG. 2C) or a rotatable state (as shown in FIG. 2B) using lights of different colors. However, the invention should not be limited thereto.

In an embodiment of the invention, the photographing device 100 further comprises a control panel (not shown in figure). When the photographing device 100 performs the VR function or the 360-degree panoramic function, the user of the photographing device 100 can use the control panel to operate the VR function or the 360-degree panoramic function. For example, the control panel may comprise a shutter key, but the invention should not be limited thereto. In another embodiment of the invention, the photographing device 100 may be connected to an external electronic device (e.g. a cell phone). When the photographing device 100 performs the VR function or the 360-degree panoramic function, the user of the photographing device 100 can use the external electronic device to operate the VR function or the 360-degree panoramic function.

In an embodiment of the invention, when the photographing device 100 performs the VR function, the photographing device 100 may be connected to a VR display device, e.g. a VR helmet or a VR glasses, but the invention should not be limited thereto.

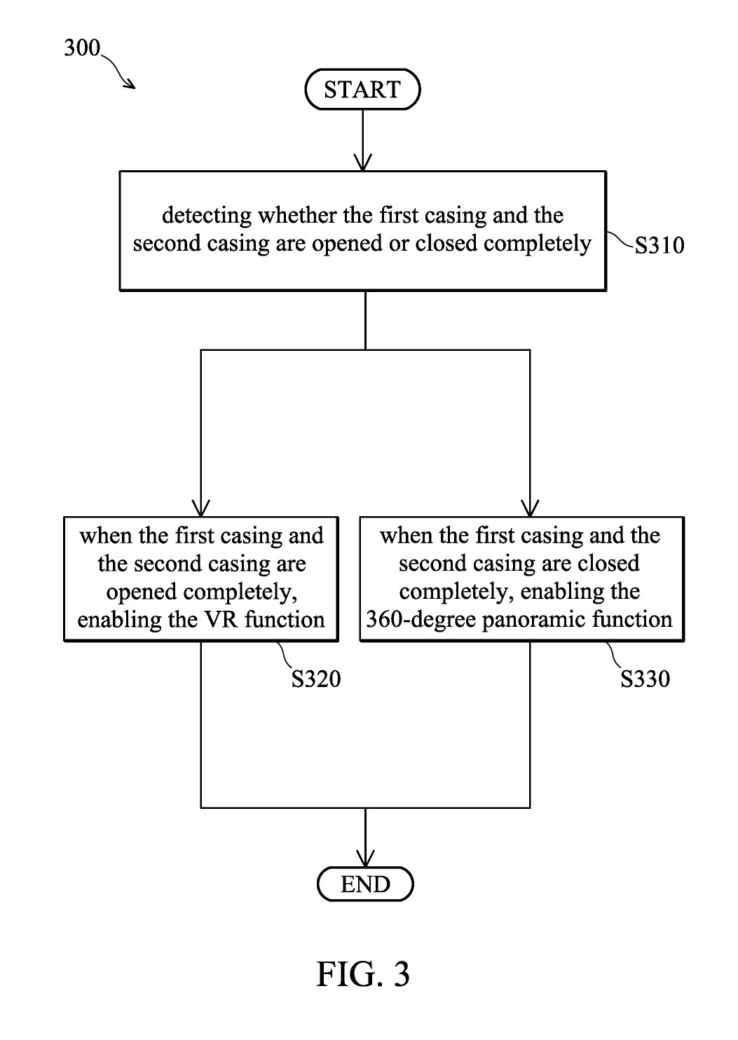

FIG. 3 is a flow chart 300 illustrating a method for switching photographing functions according to an embodiment of the invention. The method for switching photographing functions is applied to the photographing device 100. As shown in FIG. 3, in step S310, the photographing device 100 may detect whether the first casing and the second casing are opened or closed completely to determine whether to enable a VR function or a 360-degree panoramic function. When the first casing and the second casing are opened completely, step S320 is performed. In step S320, the photographing device 100 may enable the VR function. When the first casing and the second casing are closed completely, step S330 is performed. In step S330, the photographing device 100 may enable the 360-degree panoramic function.

In some embodiments of the invention, in step S310, the photographing device 100 may detect a first sensing value generated by a first sensor which is configured in the first boundary of the first casing or in the third boundary of the second casing, and the photographing device 100 may detect a second sensing value generated by a second sensor which is configured in the second boundary of the first casing or in the fourth boundary of the second casing. When the first casing and the second casing are opened completely, the second sensor may generate the second sensing value (i.e. the sensing signal S2) and the photographing device 100 may enable the VR function according to the second sensing value. When the first casing and the second casing are closed completely, the first sensor may generate the first sensing value (i.e. the sensing signal S1) and the photographing device 100 may enable the 360-degree panoramic function according to the first sensing value.

In some embodiments of the invention, in step S310, the photographing device 100 may detect a first sensing value triggered by a first mechanism which is configured in the first boundary of the first casing or in the third boundary of the second casing, and the photographing device 100 may detect a second sensing value triggered by a second mechanism which is configured in the second boundary of the first casing or in the fourth boundary of the second casing. When the first casing and the second casing are opened completely, the second mechanism may trigger the second sensing value (i.e. the sensing signal S2) and the photographing device 100 may enable the VR function according to the second sensing value. When the first casing and the second casing are closed completely, the first mechanism may trigger the first sensing value (i.e. the sensing signal S1) and the photographing device 100 may enable the 360-degree panoramic function according to the first sensing value.

In some embodiments of the invention, the method for switching photographing functions further comprises that the photographing device 100 may display information indicating whether the first casing and the second casing are currently in a fully open state, a fully closed state, or a rotatable state.

In some embodiments of the invention, the method for switching photographing functions further comprises that when the first casing and the second casing are switched from a fully open state to a rotatable state, the photographing device 100 may terminate the VR function and store the data generated by performing the VR function. When the first casing and the second casing are switched from a fully closed state to the rotatable state, the photographing device 100 may terminate the 360-degree panoramic function and store the data generated by performing the 360-degree panoramic function.

According to the photographing device and the method for switching photographing functions provided in the embodiments of the invention, the user only needs to use a photographing device to achieve the VR function and the 360-degree panoramic function.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in user equipment. Alternatively, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

Reference throughout this specification to “one embodiment” or “an embodiment” means that a particular feature, structure, or characteristic described in connection with the embodiment is included in at least one embodiment of the invention, but do not denote that they are present in every embodiment. Thus, the appearances of the phrases “in one embodiment” or “in an embodiment” in various places throughout this specification are not necessarily referring to the same embodiment of the invention.

The above paragraphs describe many aspects. Obviously, the teaching of the invention can be accomplished by many methods, and any specific configurations or functions in the disclosed embodiments only present a representative condition. Those who are skilled in this technology will understand that all of the disclosed aspects in the invention can be applied independently or be incorporated.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A photographing device, comprising:
a first casing;
a second casing;
a first wide-angle lens, assembled on the first casing;
a second wide-angle lens, assembled on the second casing;
an axle, coupled to the first casing and the second casing to open or close the first casing and the second casing; and
a controlling device, detecting whether the first casing and the second casing are opened or closed completely to determine whether to enable a virtual reality (VR) function or a 360-degree panoramic function.

2. The photographing device of claim 1, wherein the first casing has a first boundary and a second boundary and the second casing has a third boundary and a fourth boundary, wherein the second boundary and the fourth boundary are connected to the axle.

3. The photographing device of claim 2, wherein when the first casing and the second casing are opened completely, the second boundary and the fourth boundary are close-fitting, and when the first casing and the second casing are closed completely, the first boundary and the third boundary are close-fitting.

4. The photographing device of claim 3, further comprising:
a first sensor, configured in the first boundary or the third boundary; and
a second sensor, configured in the second boundary or the fourth boundary, wherein the controlling device detects a first sensing value generated by the first sensor and detects a second sensing value generated by the second sensor.

5. The photographing device of claim 4, wherein when the first casing and the second casing are opened completely, the second sensor generates the second sensing value and the controlling device enables the VR function according to the second sensing value.

6. The photographing device of claim 4, wherein when the first casing and the second casing are closed completely, the first sensor generates the first sensing value and the controlling device enables the 360-degree panoramic function according to the first sensing value.

7. The photographing device of claim 3, further comprising:
a first mechanism, configured in the first boundary or the third boundary; and
a second mechanism, configured in the second boundary or the fourth boundary, wherein the controlling device detects a first sensing value triggered by the first sensor and detects a second sensing value triggered by the second sensor.

8. The photographing device of claim 7, wherein when the first casing and the second casing are opened completely, the second mechanism triggers the second sensing value and the controlling device enables the VR function according to the second sensing value.

9. The photographing device of claim 7, wherein when the first casing and the second casing are closed completely, the first mechanism triggers the first sensing value and the controlling device enables the 360-degree panoramic function according to the first sensing value.

10. The photographing device of claim 1, further comprising:
a display panel, displaying the first casing and the second casing are in a fully open state, a fully closed state or a rotatable state currently.

11. The photographing device of claim 1, further comprising:
a control panel, configured for a user to operate the VR function or the 360-degree panoramic function.

12. The photographing device of claim 1, wherein when the first casing and the second casing are switched from a fully open state to a rotatable state, the controlling device terminates the VR function and stores the data corresponding to the VR function, and when the first casing and the second casing are switched from a fully closed state to the rotatable state, the controlling device terminates the 360-degree panoramic function and stores the data corresponding to the 360-degree panoramic function.

13. A method for switching photographing functions, applied in a photographing device which comprises a first casing and a second casing, comprising:
detecting whether the first casing and the second casing are opened or closed completely to determine whether to enable a virtual reality (VR) function or a 360-degree panoramic function;
wherein when the first casing and the second casing are opened completely, the VR function is enabled, and
wherein when the first casing and the second casing are closed completely, the 360-degree panoramic function is enabled.

14. The method for switching photographing functions of claim 13, wherein the first casing has a first boundary and a second boundary and the second casing has a third boundary and a fourth boundary, wherein the second boundary and the fourth boundary are connected to the axle, and wherein when the first casing and the second casing are opened completely, the second boundary and the fourth boundary are close-fitting, and when the first casing and the second casing are closed completely, the first boundary and the third boundary are close-fitting.

15. The method for switching photographing functions of claim 14, further comprising:
detecting a first sensing value generated by a first sensor configured in the first boundary or the third boundary; and
detecting a second sensing value generated by a second sensor configured in the second boundary or the fourth boundary.

16. The method for switching photographing functions of claim 15, further comprising:
when the first casing and the second casing are opened completely, generating the second sensing value; and
enabling the VR function according to the second sensing value.

17. The method for switching photographing functions of claim 15, further comprising:
when the first casing and the second casing are closed completely, generating the first sensing value; and
enabling the 360-degree panoramic function according to the first sensing value.

18. The method for switching photographing functions of claim 14, further comprising:
detecting a first sensing value triggered by a first mechanism configured in the first boundary or the third boundary; and
detecting a second sensing value triggered by a second mechanism configured in the second boundary or the fourth boundary.

19. The method for switching photographing functions of claim 18, further comprising:
when the first casing and the second casing are opened completely, triggering the second sensing value; and
enabling the VR function according to the second sensing value.

20. The method for switching photographing functions of claim 18, further comprising:
when the first casing and the second casing are closed completely, triggering the first sensing value; and
enabling the 360-degree panoramic function according to the first sensing value.
